(19) United States
(12) Patent Application Publication
(10) Pub. No.: US 2020/0072161 A1
(43) Pub. Date: Mar. 5, 2020

(54) LOW-FREQUENCY-SOUND-ABSORBING STRUCTURE FOR A PRIMARY NOZZLE OF A TURBOMACHINE OF AN AIRCRAFT

(71) Applicant: Airbus Operations SAS, Toulouse (FR)

(72) Inventors: Eric BOUCHET, AUSSONNE (FR); Laurent CAZEAUX, TOURNEFEUILLE (FR); Thierry GACHES, CASTELNAU D'ESTRETEFONDS (FR); Morad KASSEM, TOULOUSE (FR); Claire MAFFRE, LIAS (FR)

(21) Appl. No.: 16/552,079

(22) Filed: Aug. 27, 2019

(30) Foreign Application Priority Data
Aug. 29, 2018 (FR) 1857771

(51) Int. Cl. F02K 1/82; F02C 7/24

(52) U.S. Cl. CPC F02K 1/827; B64D 33/06; F02C 7/24

(57) ABSTRACT

A structure which absorbs low-frequency sound comprising a perforated skin, a box having two lateral walls in the shape of a strip, that delimit between them an opening, and a bottom opposite the opening connecting the two lateral walls, the lateral walls becoming closer together with increasing distance from the opening to the bottom. The box is attached to the skin at the opening. Each lateral wall extends width-wise between the opening and the bottom. Each box has two tongues, each tongue being strip shaped, extending lengthwise over an entire box length, and width-wise between the opening and the bottom of the box. Each tongue has a first end attached along an edge of the opening and a second, free end which extends towards the bottom, becoming closer to the second end of the other tongue, where each tongue has an arcuate shape along its length.

### CROSS-REFERENCES TO RELATED APPLICATIONS

This application claims the benefit of the French patent application No. 1857771 filed on Aug. 29, 2018, the entire disclosures of which are incorporated herein by way of reference.

### FIELD OF THE INVENTION

The present invention relates to a low-frequency-sound-absorbing structure for absorbing low-frequency sound from a primary nozzle of a turbomachine of an aircraft, to a primary nozzle of a primary exhaust duct of a turbomachine, to a turbomachine comprising a primary nozzle of this kind, and to an aircraft comprising a turbomachine of this kind.

### BACKGROUND OF THE INVENTION

An aircraft turbofan comprises a primary exhaust duct through which the burnt gases are expelled. The primary exhaust duct is bounded outwardly by a primary nozzle and inwardly by an inner structure (also termed “plug”). A nozzle cone is attached to the rear of the inner structure.

The primary exhaust duct is thus bounded by a skin of the primary nozzle and a skin of the inner structure, which are in contact with the flow of burnt gas from the engine.

Low-frequency sound (between 500 Hz and 1000 Hz: in particular, that linked to combustion), emitted by the turbomachine, constitutes a significant source of noise for the environment.

It is known, in order to attenuate this noise, to equip the primary nozzle and/or the inner structure with a structure that absorbs low-frequency sound.

Patent document US2013186707 discloses an absorbent structure which comprises a honeycomb structure attached between two panels, of which one is perforated and forms the skin in contact with the flow of burnt gas. The honeycomb structure comprises cells inside each of which there is arranged an element in the shape of a funnel that widens in the direction of the perforated panel.

The absorbent structure formed in this manner is very effective from the acoustic point of view since, as it is based on the same principle as a Helmholtz resonator and a quarter-wave resonator, it serves to efficiently attenuate low-frequency sound emitted by the turbomachine.

Observations show that the lowest frequency of low-frequency sound emitted by a turbomachine reduces with increasing bypass ratio of the turbomachine.

In order to be able to absorb sound over a wide range of frequencies, including sound of higher and lower frequencies emitted by high-bypass ratio (e.g. 15:1) turbomachines, it is necessary to increase the thickness of the honeycomb structure and consequently the weight of the latter. In the case where the absorbent structure is fitted to a large device such as the primary nozzle and/or the inner structure, this increase in weight makes it necessary to mechanically reinforce the absorbent structure, and therefore to further increase its weight. This increase is not desirable given the constant requirement in aeronautics to reduce the masses of the on-board systems.

It is therefore necessary to find an architecture for a low-frequency-sound-absorbing structure that is effective in order to absorb sound over a wide range of frequencies, while being less bulky and consequently less heavy.

### SUMMARY OF THE INVENTION

The invention aims to meet all or part of the above-mentioned requirement and relates to an absorbent structure.

An absorbent structure of this kind is based on the same principle as a Helmholtz resonator and a quarter-wave resonator, and serves, in particular, to efficiently attenuate low-frequency sound emitted by the turbomachine. The thickness of the absorbent structure may be increased so as to widen the range of frequencies of the attenuated sound. Since the absorbent structure is self-stiffened, an increase in the thickness of the absorbent structure does not make it necessary to add reinforcing elements to increase the mechanical strength of the absorbent structure.

### BRIEF DESCRIPTION OF THE DRAWINGS

The above-mentioned features of the invention, along with others, will become more clearly apparent on reading the following description of one exemplary embodiment, said description being given with reference to the appended figures, in which:

FIG. 1 is a side view of an aircraft comprising a turbomachine equipped with a low-frequency-sound-absorbing structure according to the invention,

FIG. 2 is a perspective view of a primary exhaust duct,

FIG. 3 is a perspective view of the low-frequency-sound-absorbing structure according to the invention,

FIG. 4 is a view in section of a low-frequency-sound-absorbing structure according to the invention, and

FIG. 5 is a perspective view of the low-frequency-sound-absorbing structure arranged on a primary exhaust duct according to the invention, and which corresponds to a section along an axial plane P in FIG. 2.

### DETAILED DESCRIPTION OF THE PREFERRED EMBODIMENTS

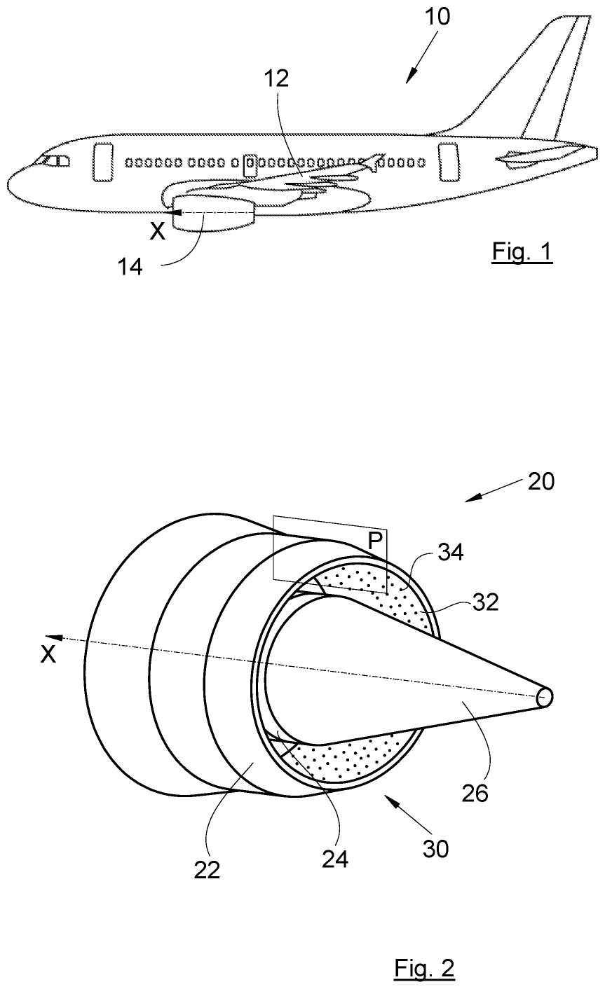

FIG. 1 shows an aircraft 10 which comprises a wing 12, beneath which there is attached a nacelle 14 which houses a turbomachine which has, at the rear, a primary exhaust duct. FIG. 2 shows the primary exhaust duct 20 which allows the gases burnt by the turbomachine to escape and which has a longitudinal axis X parallel to the longitudinal direction of the aircraft 10 and of the turbomachine.

The primary exhaust duct 20 is bounded outwardly by a primary nozzle 22 and inwardly by an inner structure 24. A nozzle cone 26 is attached to the rear of the inner structure 24.

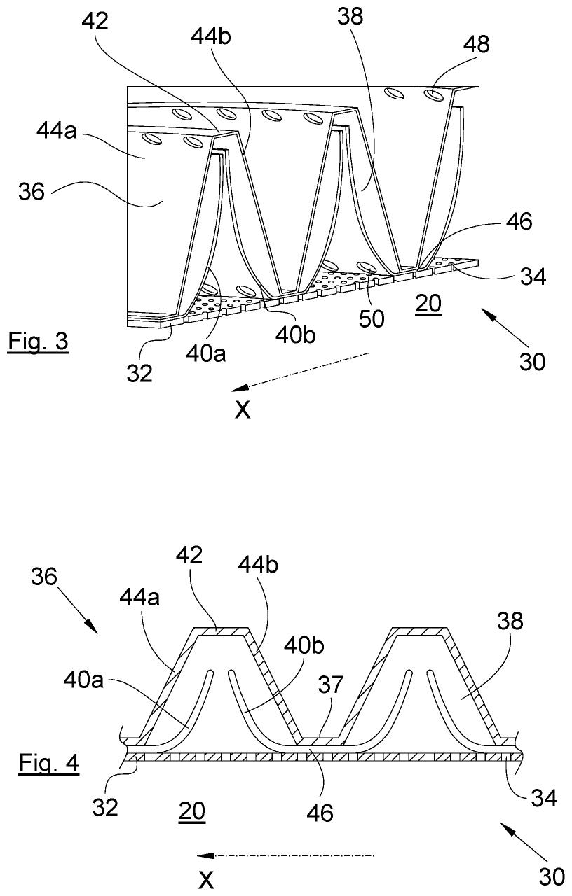

In relation to FIGS. 3 to 5, the primary nozzle 22 comprises a structure 30 that absorbs the sound emitted by the turbomachine, and which absorbs, in particular, low-frequency sound. The primary nozzle 22 and the inner structure 24 have the same longitudinal axis X.

Throughout the rest of the description, the absorbent structure 30 is described as being arranged in the primary nozzle 22, but it can be installed in the inner structure 24 or in any other part of the turbomachine or of the nacelle 14 along which there flows a flow of air and where sound is to be absorbed.

The absorbent structure 30 comprises a skin 32 which forms the surface of the primary nozzle 22 which delimits the primary exhaust duct 20. The skin 32 is perforated so that the sound waves that are to be attenuated can pass through. Thus, the skin 32 has a plurality of through-orifices 34. The air can thus flow through these orifices 34. In the context of installation in a primary exhaust duct 20, the skin 32 is in the form of a cylinder that is coaxial with the longitudinal axis X.

The absorbent structure 30 also comprises at least one box 36 attached to the skin 32 on the opposite side of the skin 32 from the primary exhaust duct 20. Each box 36 being made of walls, the walls and the skin 32 delimit a volume 38 that is open to the outside via the orifices 34. Thus, each box 36 has an opening that presses against the skin 32 and a bottom 42 which is opposite the opening. The box 36 further comprises two lateral walls 44a-b, of identical dimensions and arranged facing one another. Each lateral wall 44a-b is in the shape of a strip (that is to say, a shape that is longer than it is wide) which extends width-wise between the opening and the bottom 42. The lateral walls 44a-b delimit, between them, the opening. The bottom 42 connects the two lateral walls 44a-b to each other.

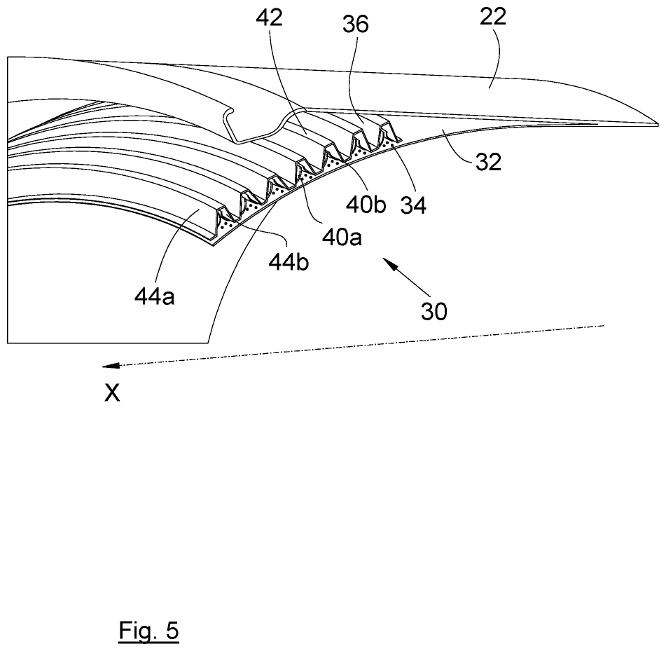

In the context of installation in a primary exhaust duct 20, and shown more particularly in FIG. 5, each box 36 exhibits symmetry of revolution and is in the shape of a crown coaxial with the longitudinal axis X of the primary exhaust duct 20, the opening being oriented towards the longitudinal axis X. Thus, each box 36 extends lengthwise along the perimeter/circumference of the primary exhaust duct 20. In the case of multiple boxes 36, these are arranged one after the other parallel to the longitudinal axis X.

Each box 36 has a trapezium-shaped profile, that is to say, a profile which narrows from the opening to the bottom 42 of the box 36. Thus, the lateral walls 44a-b become closer together with increasing distance from the opening to the bottom 42.

The absorbent structure 30 also comprises, in each box 36, two tongues 40a-b. As shown more particularly in FIG. 5, each tongue 40b-a is in the shape of a strip extending lengthwise over a length equal to that of the lateral walls 44a-b of the box 36. Thus, for a box 36 extending lengthwise along the perimeter/circumference of the primary exhaust duct 20, each tongue 40b-a also extends lengthwise along the perimeter/circumference of the primary exhaust duct 20.

When seen in section, each tongue 40a-b extends width-wise over the height of the box 36, that is to say, between the opening and the bottom 42. To that end, each tongue 40a-b has a first end attached along an edge of the opening and a second, free end which extends towards the bottom 42, becoming closer to the second end of the other tongue 40b-a. Thus, each first end is attached along a lateral wall 44a-b.

Each tongue 40b-a has an arcuate shape between the first end and the second end, and the convex shape of each tongue 40b-a, arising from its arcuate shape, is oriented towards the convex shape of the other tongue 40a-b. The two tongues 40a-b remain apart from one another so as to create a space between them.

The two tongues 40a-b will act as a quarter-wave resonator and absorb waves having a frequency of between 200 Hz and 600 Hz, and the space between the tongues 40a-b and the box 36 will act as a Helmholtz resonator and absorb waves having a frequency of between 900 Hz and 4000 Hz.

Thus, an absorbent structure 30 of this kind can absorb two types of acoustic frequency, including low-frequency sound. Moreover, the absorbent structure 30 is self-stiffened since the boxes 36 act as structural stiffeners and reinforce the structural integrity of the structure.

With reference to FIG. 4, the absorbent structure 30 comprises a first and a second box 36 arranged next to one another and secured to one another by a junction 37 arranged between the two boxes 36. A tongue 40a-b associated with the first box 36 is an extension of the tongue 40b-a associated with the second box 36 via a central part 46 which is in one piece with both tongues 40a-b and passes between the two boxes 36, being clamped between the skin 32 and the junction 37. In this case, attachment is brought about by clamping the boxes 36 and the skin 32.

In order to evacuate any fluid which might stagnate in the boxes 36, each box 36 has holes 48 close to the bottom 42 and the tongues 40a-b have holes 50 close to the opening.

In addition to the shape of revolution, these holes 48 and 50 allow the fluid to evacuate downwards.

Various types of material may be used for making the skin 32, the boxes 36 and the tongues 40a-b, for example metal such as aluminum or titanium, or composite materials.

Depending on the materials used, the elements of the absorbent structure 30 may be attached to one another for example by welding, adhesive bonding or by means of screws. Consequently, the absorbent structure 30 is easy to manufacture and to implement.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An absorbent structure for absorbing low-frequency sound, which comprises:
a skin perforated with orifices,
at least one box having two lateral walls of identical dimensions, the lateral walls being in the shape of a strip and being arranged facing one another and delimiting between them an opening, and a bottom which is opposite the opening and connects the two lateral walls, with the lateral walls becoming closer together with increasing distance from the opening to the bottom,
said box being attached to the skin with the opening against the skin, and with each lateral wall extending width-wise between the opening and the bottom, and
for each box, two tongues arranged in said box, with each tongue being in a shape of a strip extending lengthwise over a length equal to that of the lateral walls of the box, with each tongue extending width-wise between the opening and the bottom of the box and having a first end attached along an edge of the opening and a second, free end which extends towards the bottom, becoming closer to a second end of the other tongue, where each tongue has an arcuate shape between the first end and the second end.

2. The absorbent structure according to claim 1, further comprising a first and a second box arranged next to one another and secured to one another by a junction arranged between the two boxes, and wherein a tongue associated with the first box is an extension of a tongue associated with the second box via a central part which is in one piece with both tongues and is clamped between the junction and the skin.

3. A primary nozzle of a primary exhaust duct of a turbomachine, said primary exhaust nozzle having a longitudinal axis and an absorbent structure according to claim 1, wherein the skin is formed as a cylinder coaxial with the longitudinal axis and forms a surface of the primary nozzle which delimits the primary exhaust duct, and wherein each box exhibits symmetry of revolution, is arranged on the opposite side of the skin from the primary exhaust duct and is in the shape of a crown coaxial with the longitudinal axis, the opening being oriented towards the longitudinal axis.

4. The primary nozzle according to claim 3, wherein each box has holes close to the bottom, and wherein each tongue has holes close to the opening.

5. A turbomachine comprising the primary nozzle according to claim 3 and an inner structure, where the primary nozzle forms an outer boundary of a primary exhaust duct, and where an inner structure forms an inner boundary of said primary exhaust duct.

6. An aircraft comprising at least one turbomachine according to claim 5.
